(19) United States
(12) Patent Application Publication
(10) Pub. No.: US 2018/0162058 A1
(43) Pub. Date: Jun. 14, 2018

(54) Method for Determining the Points to be Supported for an Object Manufactured by Means of an Additive Manufacturing Method; Associated Information Recording Medium and Support Structure

(71) Applicants: INRIA INSTITUT NATIONAL DE RECHERCHE EN INFORMATIQUE ET EN AUTOMATIQUE, LE CHESNAY (FR); UNIVERSITE DE LORRAINE, NANCY CEDEX (FR)

(72) Inventors: SYLVAIN LEFEBVRE, VELAINE-EN-HAYE (FR); JEREMIE DUMAS, FUVEAU (FR); JEAN HERGEL, NANCY (FR)

(73) Assignees: INRIA INSTITUT NATIONAL DE RECHERCHE EN INFORMATIQUE ET EN AUTOMATIQUE, LE CHESNAY (FR); UNIVERSITE DE LORRAINE, NANCY CEDEX (FR)

(21) Appl. No.: 15/316,440

(22) PCT Filed: Jun. 2, 2015
(86) PCT No.: PCT/FR2015/051447

§ 371 Date: Oct. 17, 2017

(30) Foreign Application Priority Data
Jun. 5, 2014 (FR) 1455128

(51) Int. Cl. B29C 64/40; B29C 64/118; B29C 64/386; B33Y 10/00; B33Y 50/00

(52) U.S. Cl. CPC B29C 64/40; B29C 64/118; B33Y 50/00; B33Y 10/00; B29C 64/386

(57) ABSTRACT

A method for determining a set of points to be supported for an object to be manufactured by means of an additive manufacturing method, characterised in that it comprises a step consisting of subdividing the object into successive layers, each layer corresponding to a thickness of material deposited during the manufacture of the object; and, for each layer, adding, to a set of points to be supported, points to be supported (P_{S}) on the surface of the object that make it possible to ensure the stability of all of the sub-objects (2ₙ), a sub-object being defined as a solid resulting from the manufacture of the i first layers (Cᵢ) of the object.

The field of the invention is that of support structures for supporting an object during its fabrication by the implementation of an additive fabrication method, the support structure and the object being printed simultaneously.

An additive fabrication method consists in adding layers of material to produce the object by successive depositions of material.

Among the additive fabrication methods, 3D printing and, in particular, filament 3D printing, also called FFF printing, FFF standing for “Fused filament fabrication”, is significantly expanding, notably for the design phases of an object, before it is put into fabrication.

More specifically, a filament of material, generally a plastic, is forced through a heating and mobile nozzle. During the displacement of the nozzle along a predetermined path in a horizontal plane XY, the molten filament, extruded from the nozzle, is deposited on the material of the preceding layer and is welded thereto, thus creating an additional thickness. Step by step, by successive layers, the object is fabricated.

Filament 3D printing has a low cost price, both for the printer and for the raw material. It is also very easy to use, because it requires only a few additional steps before and after the actual printing. Upstream, it involves generating a data file geometrically describing the object to be printed by means of appropriate CAD software, then automatically determining the paths that the printing nozzle has to follow to deposit material in order to produce this geometry. Downstream, it involves separating the object from the platen of the printer on which it has been fabricated.

However, one general problem with the additive fabrication methods, in particular the 3D printing, stereolithography or similar methods, lies in the fact that the material of a layer must necessarily be deposited on an existing surface, whether that be, for the first layer, the platen on which the object is fabricated or, for another layer, the preceding layer of material.

Consequently, it is a priori not possible to directly produce, by an additive fabrication method, an object comprising overhanging portions.

To circumvent this limitation of the additive fabrication methods, it is necessary to brace the overhanging portions of the object by an appropriate support, so that the material of a layer is supported and the overhanging portion can be fabricated.

Advantageously, the support is a support structure which is fabricated at the same time as the object itself and which is separated therefrom at the end of fabrication, in a downstream step of the fabrication process.

Thus, for a filament 3D printing method, it is advisable, in an upstream step, following the generation of the geometry of the object to be printed by means of CAD software and before determining the paths that the nozzle has to follow to deposit the material and produce this geometry, to create a support structure for the object.

Methods for creating a support structure are known.

A first method leads to the creation of a robust support structure. Such a method consists first of all in extruding the surfaces to be supported of the object downward to the platen of the printer, so as to define an extrusion volume. Then, this extrusion volume is filled by using a filling pattern. The filling pattern is, for example, a honeycomb pattern. This pattern is predetermined and is not adapted to the object supported.

In a second method, which leads also to the creation of a support structure, the support structure is a regular volume lattice of which only the edges situated in the extrusion volume are retained, the edges touching the object or situated above being eliminated. An additional step consists in eliminating edges inside the extrusion volume to further simplify the support structure. The support structure is therefore always a subset of the original regular lattice.

The geometry of the support structure obtained by means of these methods is therefore partly independent of the object to be printed, since the elements forming the lattice and their positions are predetermined by the lattice pattern chosen originally. In particular, these elements cannot be positioned or oriented locally as a function of the geometry of the object to be supported which leads to a larger support structure. Furthermore, in order to guarantee that such a support structure remains printable, it is necessary to keep columns, which consist of a set of edges forming minimal printable structures, which limits the maximum possible reduction and increases the complexity of the algorithm for eliminating edges from the lattice.

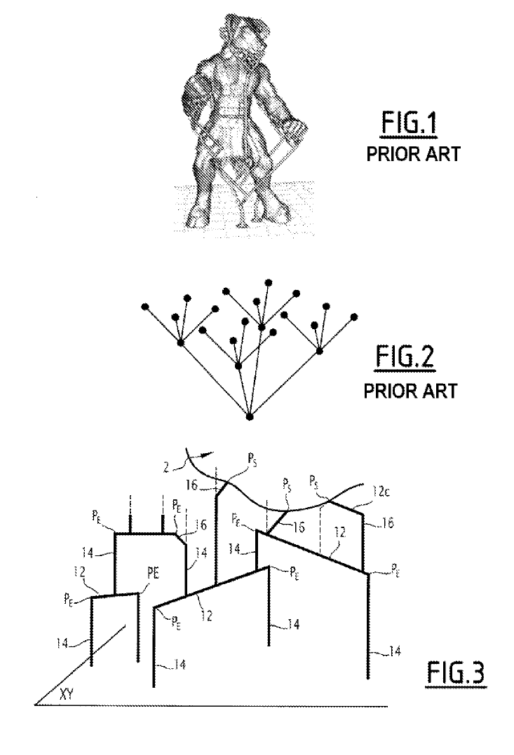

A third method, the algorithmic details of which are kept secret, leads to the creation of a tree support structure. Such a support structure bracing a figurine is illustrated by FIG. 1. A tree support structure is represented schematically in FIG. 2, the end points, forming the “leaves” of the tree, being the points to be supported on the surface of the object to be printed.

A tree support structure is lightweight. It requires little raw material and, consequently, a shorter printing time.

However, this second type of method is not deterministic and leads, from one and the same object, to determining several possible tree support structures. Now, some of these possible structures are not mechanically stable: they are not sufficient to support the object during its fabrication and the overhanging portions are likely to sag during the printing, leading to the fabrication of an object exhibiting defects.

To choose the right tree support structure, it is necessary either to proceed with a complex mechanical simulation, the exact parameters of which are very difficult to determine, or proceed with printing tests with different possible tree structures, and choosing that which led to the fabrication of an object exhibiting the least defect. Such a trial/error type method is inefficient in the 3D printing field. It leads notably to a significant consumption of raw material and high printing times. It also requires specific training of the operators designing the support structures.

The aim of the invention is therefore to mitigate the abovementioned problems, by notably proposing an automatic method for creating a support structure for an object to be produced by means of an additive fabrication method, which is mechanically robust while remaining lightweight, that is to say requiring only a small quantity of material and a reduced printing time, the creation consisting, firstly, in defining points of the object to be supported, then, in generating a support structure from these points to be supported.

The subject of the invention is a method for determining a set of points to be supported for an object having to be fabricated by means of an additive fabrication method, characterized in that it comprises a step consisting in subdividing the object into successive layers, each layer corresponding to a thickness of material deposited during the fabrication of the object; and for each layer, adding, to a set of points to be supported, points to be supported on the surface of the object which make it possible to guarantee the stability of all the sub-objects of the object, a sub-object being defined as a solid resulting from the fabrication of the i first layers of the object.

According to particular embodiments, the support structure comprises one or more of the following features, taken in isolation or in all technically possible combinations:
The method comprises, to guarantee the stability of any sub-object, a step consisting in checking that each sub-object placed on a horizontal base plane is in stable static equilibrium, a step during which it is checked whether a so-called center-of-mass disk, the center of which corresponds to the projection of the center of mass of said sub-object and having a predefined radius, is entirely situated within a base surface of said sub-object.
If it is confirmed that the sub-object is unstable, the method comprises a step consisting in increasing the base surface of said sub-object by providing at least one substantially vertical support element between a point of contact of the base plane located outside the base surface and a point to be supported on the surface of the sub-object projected vertically outside of the base plane of the sub-object and located at a distance from said point of contact less than a distance corresponding to the radius of said center-of-mass disk, said point to be supported on the surface of the sub-object thus defined being added to the set of the points to be supported.
The substantially vertical support element provided is either a vertical pillar linking the point of contact and the point to be supported on the surface of the sub-object, or a vertical pillar and a horizontal connecting bridge connecting the top end of said vertical pillar and said point to be supported on the surface of the sub-object.
Prior to the step consisting in adding, to a set of the points to be supported, points to be supported on the surface of the object which make it possible to guarantee the stability of all the sub-objects of the object, the method comprises the steps consisting in, for each layer: defining at least one path for fabrication of the current layer; and, for each point of a plurality of points along said path, testing a condition of support, by the preceding layer, of the material deposited at the point considered; and, in case of noncompliance with the support condition, adding the unsupported point to the set of the points to be supported.
In case of noncompliance with the support condition, an additional step of verification of a distance criterion, the unsupported point being added to the set of the points to be supported if a distance between the unsupported point and a neighboring point, belonging to the set of the points to be supported, is greater than a threshold distance.
The or each path being of the perimeter path type, when it belongs to a portion of the perimeter of the current layer, or of the internal path type, when it belongs to an internal portion of the current layer, for an unsupported point of a path of the perimeter path type, the distance criterion implemented consists in evaluating a curvilinear distance along said path between the unsupported point and a neighboring point, defined as the closest point out of the set of the points to be supported which belong to the current layer; whereas, for an unsupported point of a path of the internal path type, the distance criterion implemented consists in evaluating a rectilinear distance between the unsupported point and a neighboring point, defined then as the point closest to the unsupported point out of the set of the points to be supported which belong to the current layer and to the layers below the current layer.
The method comprises an additional step of determination of the plurality of points to be considered in the step consisting in testing a support condition, during which the or each path is broken down into elementary paths extending between two successive angular points of said path, and, when the length of an elementary path is greater than a threshold length, subdividing said elementary path into as many elementary paths, said plurality of points consisting of the ends of each of the elementary paths.
The support condition tested on a point consists in calculating the fraction of the surface of a disk which covers the preceding layer, said disk being centered on the point considered and having a predefined radius, the point considered being unsupported when said fraction is less than a threshold fraction, for example 50%.
The set of the points to be supported guarantees that the filament is held up during the fabrication of the object by the implementation of an additive fabrication method using a filament 3D printer.

Another subject of the invention is an information storage medium, characterized in that it comprises instructions for the execution of a method according to the preceding method.

Another subject of the invention is a support structure for supporting an object during its fabrication by implementing an additive fabrication method, the support structure and the object being printed simultaneously, characterized in that it supports the object at a plurality of points belonging to a set of the points to be supported resulting from the implementation of a method for determining a set of points to be supported according to the preceding method.

Preferably, the structure comprises at least one substantially vertical element between a point of contact of a base plane and a point to be supported on the surface of the object belonging to the set of the points to be supported, said substantially vertical element being either a vertical pillar, linking the point of contact and the point to be supported, or a vertical pillar and a horizontal connecting bridge connecting the top end of said vertical pillar to said point to be supported.

More preferably, the structure is made up of a plurality of horizontal and rectilinear bridges, vertical pillars and inclined connectors, a bottom end of a pillar resting on a bridge, on a base plane or on the surface of the object, and a top end of a pillar bearing a connector, and a bottom end of a connector resting at the top end of a pillar and the top end of a connector bearing a point to be supported of the object or a point to be supported of a bridge, each bridge being supported at least at each of its two end points, either by a pillar or by a point to be supported of the object.

The invention will be better understood on reading the following description of a particular embodiment, given purely in an illustrative and nonlimiting manner, and with reference to the attached drawings in which:

FIG. 1 is a graphic representation of an object printed with a tree support structure according to the prior art;

FIG. 2 is a schematic representation of a tree support structure according to the prior art, the end points, forming the “leaves” of the tree, being the points to be supported on the surface of the object to be printed;

FIG. 3 is a schematic representation of a support structure according to the invention;

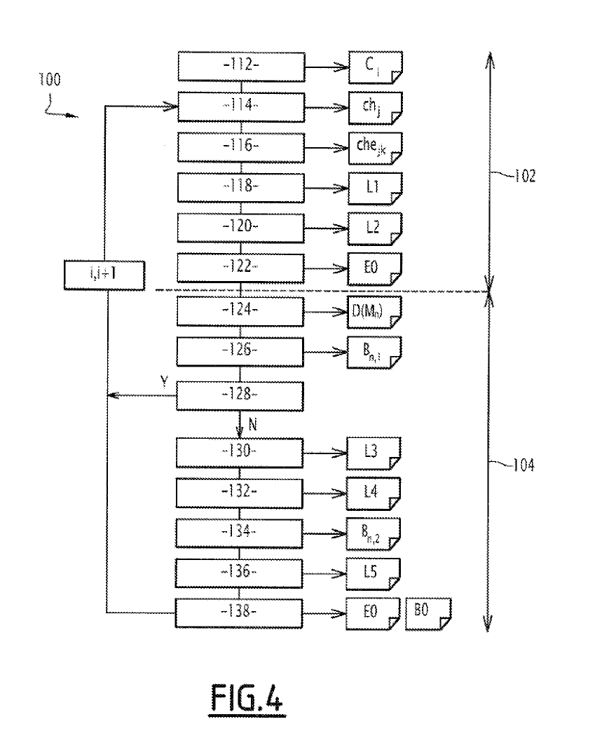

FIG. 4 is a block-form representation of a method for defining the set of the points to be supported on the surface of the object, whatever the nature of the final support structure supporting the points to be supported thus defined (structure according to the prior art, for example tree structure, or according to the invention);

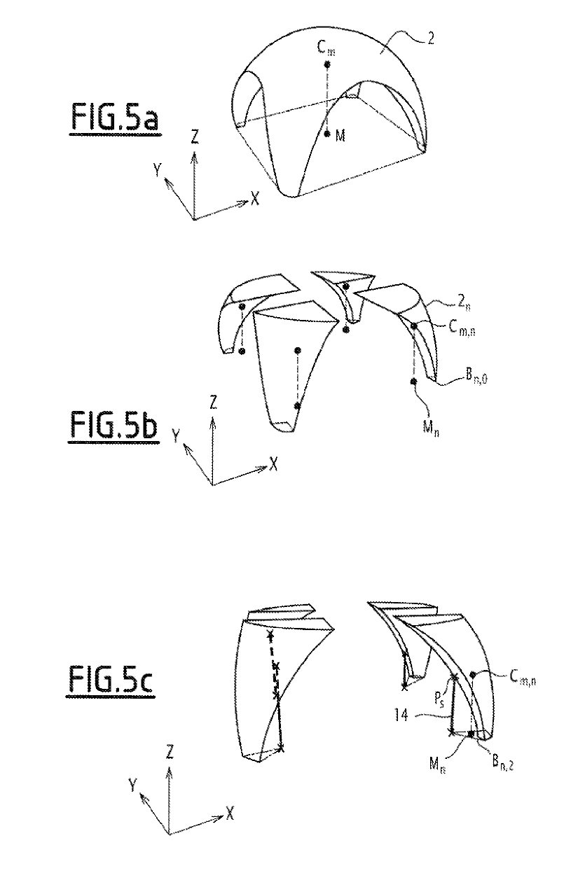

FIGS. 5a to 5c represent a single-piece object, the fabrication of which by an additive fabrication method involves the formation of intermediate sub-objects, the method for defining the set of the points to be supported according to the invention making it possible to brace each sub-object;

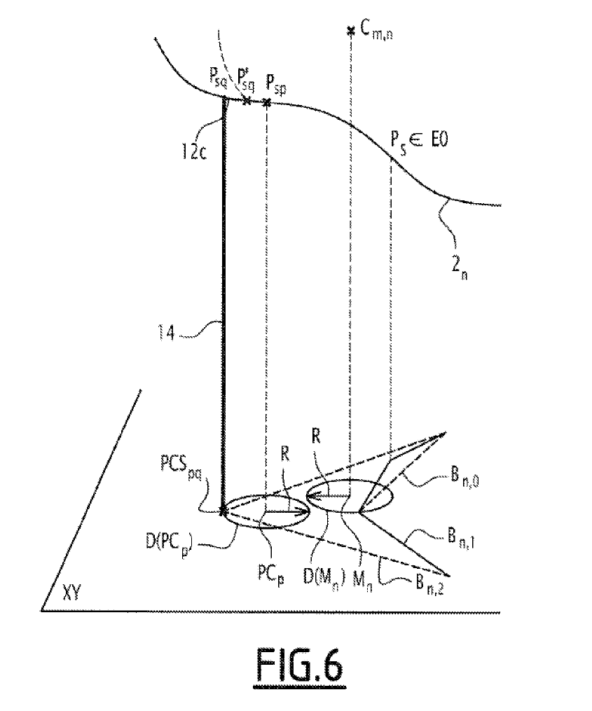

FIG. 6 is a perspective schematic representation of the points used in the method of FIG. 4;

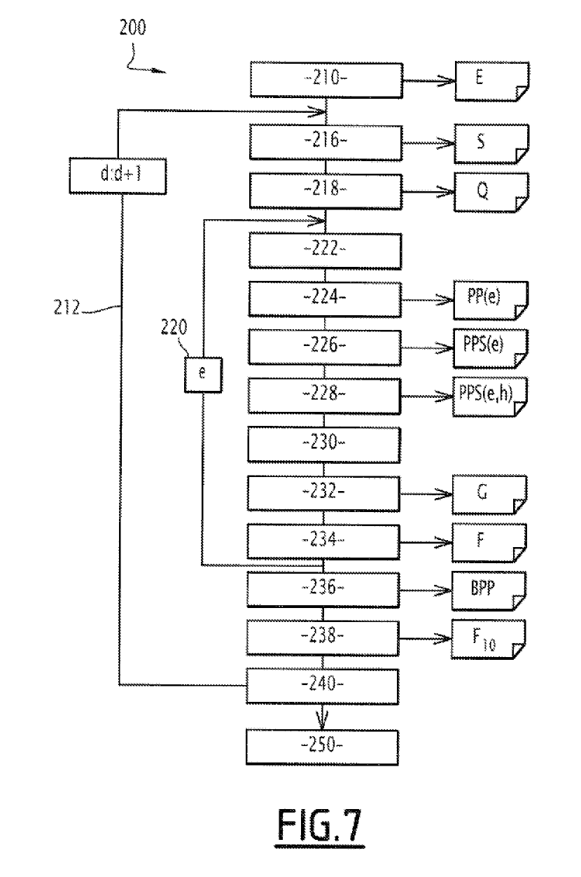

FIG. 7 is a block-form representation of a method for automatically generating a support structure according to the invention, from the data of a set of points to be supported on the surface of the object to be printed, whether or not this set results from the implementation of the method for defining a set of points to be supported according to FIG. 4;

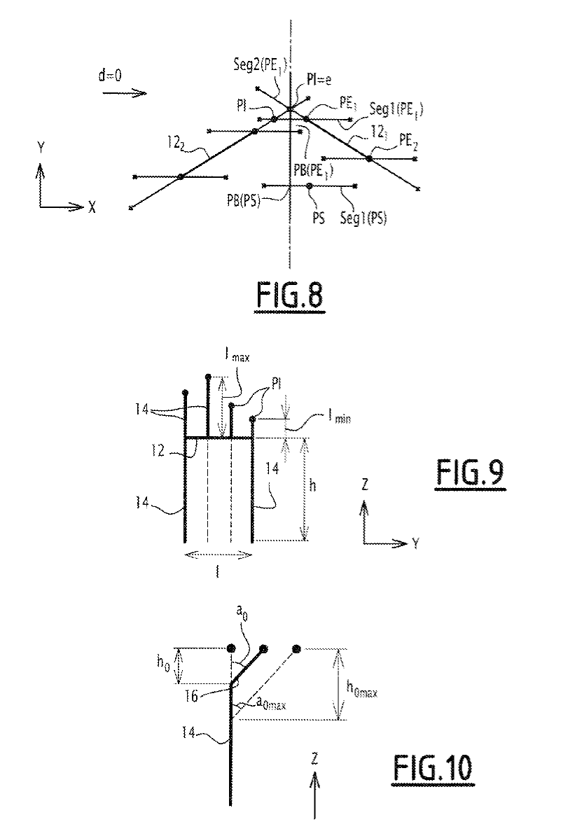

FIG. 8 is an illustration of the concepts of “segment” and “event” used in the method of FIG. 7;

FIG. 9 is an illustration of a possible bridge;

FIG. 10 is a schematic representation of a substantially vertical element, pillar or connector, of the support structure according to the invention comprising a vertical lower portion and an inclined upper portion; and

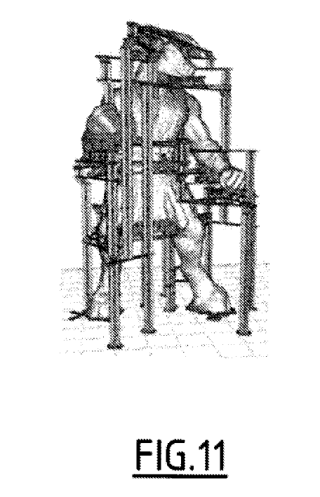

FIG. 11 is a graphic representation of the object of FIG. 1 with a support structure according to the invention.

In the following description, the additive fabrication method that is envisaged being implemented to fabricate the object and its support structure is a filament 3D printing method. A person skilled in the art will know how to adapt the technical teaching of the present description to other types of additive fabrication method.

### Support Structure

The implementation of the method according to the invention leads to the creation of a support structure designed, in a final step of fabrication by means of a filament 3D printer, to be printed with the object so as to hold it up at each instant in the printing thereof.

A support structure 10 is illustrated in FIG. 3. FIG. 11 represents the case of the printing of an object 2 representing a figurine, identical to that of FIG. 1, braced with the support structure according to the invention.

The surface of the object 2 is generally referenced by the numeral 4.

The support structure 10 braces the object 2 at a plurality of points to be supported P_{S} situated on the surface 4 of the object 2.

The support structure 10 comprises a plurality of bridges 12, pillars 14 and connectors 16.

A bridge 12 is a horizontal and rectilinear component.

A bridge has a length l between its two end points, and a height h above the base plane consisting of the platen of the filament 3D printer. Hereinbelow, the platen of the printer is identified with a horizontal base plane XY, the normal to this plane constituting the axis Z of the dimensions.

A bridge 12 is supported at least at each of its two end points. In the embodiment described here in detail, a bridge 12 is supported only at each of its two end points. However, in a variant embodiment of the support structure, a bridge can be supported not only at each of its two end points, but also at at least one other intermediate point.

A bridge can be of three possible types: either it is supported at each of its two end points by pillars 14; or it is supported at one end point by a pillar 14 and the other end point corresponds to a point situated on the surface 4 of the object 2; or each of its two end points correspond to points situated on the surface 4 of the object 2. It should be noted here that a point on the surface of the object is not necessarily a point to be supported on the surface of the object as defined below in relation to the methods according to the invention. That will only be the case if these points originate from a stability analysis as described below. However, the algorithm for implementing the method for generating the structure may decide, if it is so allowed, to anchor a bridge on the surface of the object, at any point thereof, to avoid forming a pillar.

The bridges of the second and third types are called “connecting bridges” hereinbelow. They are indicated by the reference 12C, as for example in FIG. 5. Unless otherwise stipulated, a bridge 12 is a bridge of the first type. In a variant, the structure comprises only bridges of the first type.

A pillar 14 is vertically oriented. It bears, by its bottom end, either directly on a bridge 12, or directly on the base plane, or even directly on the surface 4 of the object 2.

A pillar 14 supports, indirectly via a connector 16, either an end point Pₑ of a bridge 12, or a point to be supported P_{S} on the surface 4 of the object 2.

As represented in FIG. 7, a connector forms an angle a₀ less than a maximum angle a₀ₘₐₓ and has a height h₀ less than a height h₀ₘₐₓ. Generally, these two parameters are constrained simultaneously for a connector 16 not to exceed a maximum angle of inclination which would risk exhibiting a low mechanical strength and being difficult to print.

It should be noted that a pillar 14 can have a zero height, such that a bridge 12 situated above rests directly on a bridge 12 situated below, or a connector 16 bears by its bottom end directly on a bridge.

A connector 16 can also have a zero height, such that a pillar 14 supports a point which is situated directly vertical to the point of the bridge on which the pillar considered bears.

As represented in FIG. 10, a bridge 12 directly supports at least n pillars 14 (a pillar being able to have a zero height), that is to say supports n points to be supported out of the end points of bridges 12 situated above or points to be supported P_{S} on the surface 4 of the object 2.

Since the benefit of a bridge 12 is to reduce the number of points to be supported P, by replacing the n points that it supports with the p pillars 14 which support it, it is desirable for the integer n to be greater than the integer p. In the embodiment described here in detail, p being equal to 2, it is desirable for n to be greater than or equal to 3. This constraint is implemented by a suitable gain function G in the method for generating the support structure, which will be described hereinbelow.

In a variant embodiment, if the pillars are too high, it is preferable to add an intermediate rigidifying bridge. Such a bridge supports a vertical pillar and is supported by two vertical pillars. This makes it possible to rigidify the structure and avoid effects of buckling of a pillar which would be too high.

The bridges 12 and the connecting bridges 12C are, seen from above, that is to say in projection in a horizontal plane XY corresponding to the base plane, distributed according to d directions. A direction should be understood to mean the two possible directions along a straight line. Preferably, the directions are deduced from one another by rotations of π/d.

In the case of the use of a filament 3D printer, a bridge 12 consists of at least one filament printed between two end points to be supported consisting of the top ends of the two pillars 14 supporting the bridge 12 considered. Similarly, a connecting bridge 12C consists of at least one filament printed between two points to be supported consisting of a point to be supported P_{S} of the surface 4 of the object 2 and the top end of the pillar 14 which supports it.

It has been found that it is possible to use a filament 3D printer to stretch a material filament over a void between two support points, the distance of which is less than a maximum reach Dₘₐₓ of a few centimeters. The hot filament is extruded so as to be welded at the two support points forming, between these two points, a catenary. When the filament cools, the filament material shrinks so as to form a substantially horizontal bridge.

Thus, in the embodiment currently envisaged, a bridge 12 (respectively 12C) consists of two successive layers.

Each layer has a thickness of 0.4 mm. It consists of two filaments arranged side-by-side, at a distance of 0.8 mm from one another, a distance which corresponds substantially to the diameter of the filament used.

The bridges 12 (respectively 12C) thus formed exhibit sufficient mechanical properties to serve as elementary components of a support structure of an object. It has thus been found that a bridge 12 (respectively 12C) can on its own support several grams. Now, the objects to be printed often use less than 10 m of filament (for a filament of 1.75 mm diameter, that represents an object of approximately 25 g) and are braced by a support structure comprising several bridges. The object is therefore correctly supported mechanically.

Each vertical element, pillar 14 or connector 16, preferably has a cross-shaped cross section. Such a section allows both for a reduced consumption of raw material and therefore rapid printing, while offering good rigidity. Obviously, other choices of section can be envisaged.

The support structure 10 of the object 2 of FIG. 3 weighs 0.5 g, whereas the object itself weighs approximately 10 g.

### Method for Defining the Set of the Points of Contact to be Held Up

There now follows a description of a method making it possible to define a set E0 of points to be supported on the surface of an object to be fabricated.

This definition method 100, which constitutes a first aspect of the invention, is independent of the method for generating the support structure, which will actually be used hereafter, in particular of the generation method 200 described hereinbelow and forming a second aspect of the invention.

Thus, the implementation of the method 100 leads to the definition of a set E0 of points to be supported P_{S} on the surface 4 of the object 2. The set E0 combines the points of the surface 4 of the object 2 that have to be braced by the support structure 10.

Incidentally, since a pillar 14 of the support structure 10 can bear either on a bridge 12, or on the base plane XY, or even on the surface 4 of the object 2 itself, the set of the points of contact between the support structure 10 and the object 2 comprises not only the set E0 of the points to be supported P_{S}, but also the points of the surface 4 of the object 2 on which bear some of the pillars 14 of the support structure 10.

Advantageously, the method 100 makes it possible to define a set E0 which, by the implementation of a first series of steps 102, makes it possible to hold up the filament during the printing and which, by a second series of steps 104, makes it possible to ensure the stability of the object at each instant of the printing.

For that, the method 100 comprises a first series of steps consisting in determining points to be supported P_{S} which together make it possible to hold up the filament during the printing.

In a step 112, the object 2 to be printed is subdivided into horizontal layers, each layer Cᵢ corresponding to the thickness of material deposited on each pass of the nozzle of the filament 3D printer. In this step, only the object 2 is considered. The index i corresponds to a pitch along the axis Z of the dimensions.

The subsequent steps are iterated for each layer Cᵢ, that is to say over the integer i. The latter is not recalled on each step to lighten the notations.

In the step 114, for each layer C the paths chⱼ followed by the nozzle to print the layer considered are determined. The paths are either of the perimeter path type, when they belong to the edge forming the perimeter of the layer Cᵢ or of the internal path type, when they belong to the interior of the layer Cᵢ that is to say the layer Cᵢ from which the edge forming its perimeter has been removed.

In the step 116, each path chⱼ is broken down into elementary paths cheⱼₖ, each segment extending between two successive angular points of the path, that is to say two points where there is a significant change in the direction of displacement of the nozzle. When the length of an elementary path is greater than a threshold length l₀ (5 mm for example), it is subdivided into as many elementary segments. The threshold length l₀ constitutes an adjustable parameter of the method.

In the step 118, the end points of the elementary paths cheⱼₖ are placed in a first list L1. The list L1 is ordered as a function of the path of the nozzle for printing the current layer Cᵢ.

The step 120 consists in verifying that each point P1 of the first list L1 is supported by the layer Cᵢ₋₁, situated immediately below the current layer Cᵢ.

This verification consists in calculating the fraction of the surface of a disk D(P1) supported by the layer Cᵢ₋₁, this disk being centered on the point P1 and having a predefined radius, corresponding for example to the diameter of the nozzle (0.4 mm in the practical implementation of the present method).

If more than a threshold percentage (predefined and adjustable), for example equal to 50%, of the surface of the disk D(P1) is not supported by the preceding layer, the point P1 is considered to be an unsupported point. It is entered into a second list L2, which is ordered according to the path of the nozzle for printing the layer Cᵢ.

In the step 122, the second list L2 is scanned. If a point P2 of the list L2 belongs to a path chⱼ of the perimeter type, it is selected from the set E0 of the points to be supported P_{S}, if the distance between the point P2 and a neighboring point PV (defined as the point of the set E0 belonging to the layer Cᵢ closest to the point P2 considered) is greater than a threshold distance τ, the distances being, here, curvilinear distances evaluated along the path considered.

On the other hand, if the point P2 of the list L2 belongs to a path chⱼ of the internal type, the unsupported point P2 is selected from the set E0 of the points to be supported, if the distance between the point P2 and a neighboring point PV (defined then as the point of the set E0 belonging to the layer Cᵢ considered or to a lower layer, Cⱼ with j<i, closest to the point P2 considered) is greater than the threshold distance τ, the distances being, in this second alternative, rectilinear distances.

At the end of step 122, the set E0 of the points to be supported is determined.

Thus, at the end of this first series of steps 102, a set of points to be supported is defined which makes it possible to guarantee that the filament is maintained during the printing of the object. As a variant, other series of steps could be implemented to determine such a set of points to be supported guaranteeing that the filament is maintained during the printing.

The method 100 advantageously continues with a second series of steps 104 consisting in complementing a set of points to be supported with additional points situated on the surface 4 of the object 2, so as to guarantee the stability of the object 2 at each instant of the printing thereof. The set of the points to be supported considered at the start of this second series of steps is advantageously the set E0 of the points to be supported defined in the first series of steps presented above.

The layer-by-layer printing of a single-piece object 2 often involves the printing of intermediate sub-objects 2ₙ which are independent to a certain height and which are welded together at a higher height. This is illustrated in FIG. 5 by an object 2 in dome form, the four sub-objects 2ₙ of which in leg form are linked to one another only at the moment of the printing of the key stone.

Each sub-object 2ₙ may be unstable before being joined to another sub-object to form the object 2. A sub-object 2ₙ may possibly fall or topple, leading to a defective print. This problem is a generic problem with additive fabrication. It is notably present in the stereolithography methods.

The implementation of the method performs an analysis making it possible to evaluate, on each layer Cᵢ of material added by the filament 3D printer, the stability of at least one sub-object 2ₙ hitherto printed.

It is stressed that the method does not take into account the possibility of using a binding agent in order to bond the object to be printed onto the platen of the printer. However, the use of such a glue can only improve the stability of any sub-objects of the object.

Furthermore, it is assumed that said sub-object is rigid.

Checking that a sub-object 2ₙ placed on the base plane XY is in stable static equilibrium consists in checking whether its center of mass C_{m,n} is projected vertically at a point Mₙ situated inside a base surface Bₙ of the sub-object 2ₙ.

The base surface Bₙ of a sub-object 2ₙ is the smallest convex polygonal surface comprising all the points of the sub-object 2ₙ in contact with the base plane XY.

The following steps aim to increase the base surface Bₙ of an unstable sub-object 2ₙ, by the addition of a vertical pillar 14 between a new point of contact P_{c} on the base plane XY and a new point to be supported P_{S} on the surface 4 of the sub-object 2ₙ. The mechanically stable system then consists of the sub-object 2ₙ and the added vertical pillar 14.

In the present embodiment, only the possibility of adding a vertical pillar 14 between a point of contact P_{c} on the base plane XY and a point to be supported P_{S} on the surface of the sub-object is considered. However, in the determination of the support structure to be printed, as is described below in detail, this point to be supported P_{S} will be able to be supported not by a single vertical pillar 14, but by a group of pillars 14 and bridges 12. However, the set of the points of contact of this group of pillars and of bridges on the base plane XY leads to an increase in the base surface B which is greater and which includes the increase in the base surface B generated by the single point of contact P_{c}. This devolves from the fact that the base surface is, by definition, convex and that the bridges are always supported at each of their two ends by pillars, such that, if the point to be supported P_{S} is supported via a bridge, a support pillar for this bridge will be outside of the base surface determined by considering just the vertical projection of the point to be supported P_{S}. Thus, during printing, the support structure can only improve the stability of the sub-object by comparison to the use of a single vertical pillar.

In the step 124, for the current layer Cᵢ for the or each sub-object 2ₙ, the projection Mₙ on the base plane XY of its center of mass C_{m,n} is determined. Advantageously, this is performed by taking into account printing paths chⱼ and not just the volume delimited by the surface 4 of the sub-object 2ₙ. In effect, the interior of the sub-object may be solid, produced in honeycomb form, etc., which influences the position of the center of mass C_{m,n} and consequently that of the point Mₙ on the base plane XY.

The static equilibrium of a sub-object can be disturbed by the forces applied by the nozzle in the deposition of material. This is why it is verified whether a disk D(Mₙ), centered on the point Mₙ and having a predefined radius R, is situated fully within the base surface Bₙ of the sub-object 2ₙ.

The radius R of the disk is, for example, equal to 3 mm. In a variant embodiment, the radius of the disk depends on the weight distribution around the center of mass and on the height between the center of mass and the platen, so as to take account of a lever arm effect.

In the step 126, for the iteration on the layer Cᵢ, an initial base surface B_{n,0} (FIG. 6) is enlarged.

In the analysis of the first layer C₁, the initial base surface B_{n,0} is initialized with the minimal convex polygon comprising all the points of contact P_{c} of the first layer C₁ of the sub-object 2ₙ on the base plane XY.

On each iteration, the initial base surface B_{n,0} is first of all enlarged by taking into account, as additional point of contact, the projection on the base plane XY of each point to be supported P_{S} of the set E0 and which belongs to the layer Cᵢ. An increased base surface B_{n,1} is obtained.

In the step 128, it is then verified whether the disk D(Mₙ) is entirely contained inside the increased base surface B_{n,0}.

If it is, the method goes onto the next layer Cᵢ₊₁ and resumes at the step 114. For the next iteration, the initial base surface B_{n,0} takes the value of the increased base surface B_{n,1}.

If not, an additional point of the surface of the sub-object must be added to the set E0 of the points to be supported.

In a particular embodiment, an additional point is chosen as follows.

In the step 130, a third list L3 of candidate points of contact PCₚ is determined. A candidate point of contact of this third list is a point of the base plane corresponding to a point PSₚ of the surface 4 of the sub-object 2ₙ which is projected outside of the increased base surface B_{n,1} (this point not necessarily belonging to the current layer Cᵢ). It should be noted that the surface of the object is sampled or pixelated such that the list L3 comprises a finite number of points.

By constructing a vertical pillar from this candidate point PCₚ, to brace this point PSₚ of the surface of the sub-object 2ₙ, there is therefore a priori the possibility of increasing the base surface Bₙ of the sub-object braced by this pillar and of making the corresponding system stable.

A circle D(PCₚ) of secondary candidate points PCS_{pq} around each candidate point PCₚ is in fact considered. This circle has a radius equal to the radius R of the disk D(Mₙ), so as to guarantee that the base surface Bₙ will be able to be modified so as to encompass all of the disk D(Mₙ).

In the step 132, for each secondary candidate point PCS_{pq} of the circle D(PCₚ), the percentage of the surface of the disk D(Mₙ) which would be encompassed by the variation of the increased base surface B_{n,1}, if this secondary candidate point PCS_{pq} constituted a point of contact of the system, is determined. The points PCS_{pq} associated with the different candidate points PCₚ of the list L3 are placed in a fourth list L4 in descending order of the duly calculated percentage. Here again, the perimeter of the disk is sampled or pixelated such that the list L4 comprises a finite number of points.

Then, in the step 134, by successive iterations on the points PCS_{pq} of the list L4, the increased base surface B_{n,1} is enlarged to obtain an enlarged base surface B_{n,2}.

On each integration of a new secondary candidate point PCS_{pq}, the base surface is recalculated and it is verified whether all of the disk D(Mₙ) is situated inside the recalculated base surface.

This process is stopped when all of the disk D(Mₙ) is situated inside the recalculated base surface, which is then stored as enlarged base surface B_{n,2}. The list L4 is then truncated so as to retain only the secondary candidate points used.

Because of the order in which the points of the list L4 are taken into account, it is possible for points added in the first iterations not to ultimately contribute to the enlarged base surface B_{n,2}, that is to say not to be situated on the perimeter of this modified base surface, but inside the latter. These points are, in the step 136, removed from the points used to increase the base surface. A fifth list L5 of points is then obtained from the truncated list L4.

The enlarged base surface B_{n,2} constitutes the initial base surface B_{n,0} for the next iteration of the method relating to the next layer Cᵢ₊₁.

The list L5, made up of the points of contact on the base plane XY, is used in the step 138 to determine the new points P_{S} of the surface 4 of the sub-object 2ₙ to be supported to guarantee the stability during printing.

For that, in the step 138, for each point PCS_{pq} of the list L5, the point of intersection is calculated between a vertical deriving from the point PCS_{pq} considered and the surface of the sub-object 2ₙ restricted to the current layer Cᵢ and to the lower layers, Cⱼ with j<i.

When it exists, this point of intersection P_{sq} is added to the set E0 as new point to be supported.

If the vertical does not intersect the surface of the sub-object 2ₙ restricted to the current layer Cᵢ, a connecting bridge 12C is added in a set B0 of connecting bridges. This connecting bridge 12C links the top end of the vertical deriving from the point PCS_{pq} considered (end situated at the level of the current layer Cᵢ) and a point P′_{sq} of the surface of the sub-object 2ₙ, the vertical projection of which is located inside the circle D(PCₚ) on the perimeter of which the point PCS_{pq} considered is situated.

Then, the method 100 loops to analyze the next layer Cᵢ₊₁ of the object.

At the end of the method, a set E0 of points to be supported P_{S} on the surface of the object and a set B0 of bridges, comprising connecting bridges 12C, are obtained.

### Method for Generating a Support Structure

The method for generating a support structure constituting a second aspect of the present invention takes as input a set of points to be supported. This set is advantageously defined by the implementation of the method presented hereinabove, but can be defined by any of the methods from the prior art.

The method 200 for generating a support structure 10 of the object 2 thus begins with a step 210 of initialization of a set E of points to be supported P, which results from the combining of the set E0 of the points to be supported P_{S} on the surface 4 of the object 2, obtained as output of the method 100, and of the free end points P_{E} of each connecting bridge 12C of the set B0, obtained as output from the method 100.

More generally, the free end point P_{E} of a bridge is an end point which is not yet supported. It is therefore a point constituting a degree of freedom in the construction of the support structure: it can be displaced by stretching the corresponding bridge to search for a bearing point situated in the vertical alignment thereof on a bridge situated lower, or, optionally, on a part of the surface of the object situated in the vertical alignment thereof.

The method continues with a loop 212 to a set of scanning directions. A scanning direction in the plane XY is at right angles to the corresponding scanning plane which is consequently vertical. Preferably, the method takes into account a number d of scanning directions.

In the embodiment described here in detail, these directions are separated angularly by π/d. In a variant, the set of the directions results from a step of geometrical analysis of the object 2 to determine if it exhibits preferred directions.

For reasons of symmetry, it is not necessary to consider the directions beyond π. The direction d=0 corresponds to the direction according to direction X.

For reasons of clarity, the case of the iteration in which the scanning direction corresponds to the axis X (d=0) is described in detail hereinbelow.

In the step 216, the method continues with the creation of segments from each point to be supported P of the set E and the current scanning direction, in this case the direction X.

As is represented in FIG. 8, a segment of the first type Seg1 is generated from each point of the set E which is of the type of a point to be supported P_{S} on the surface 4 of the object 2. It is a segment of length 2×lₘₐₓ parallel to the current scanning direction and centered on the point to be supported P_{S}.

A segment of a first type Seg1 is also generated from each point of the set E which is of the type of a free end point P_{E} of a bridge 12, such as the point P_{E1} of the bridge 12₁. Here again, it is a segment of length 2×lₘₐₓ, parallel to the current scanning direction and centered on the free end point P_{E} considered of the bridge 12.

A segment of a second type Seg2 is generated from each point of the set E which is a free end point P_{E} of a bridge 12, such as the point P_{E1} of the bridge 12₁. It is a segment parallel to the direction of the bridge 12₁ and extending away from the latter, beyond the free end point P_{E1}.

If both the end points of the bridge 12 are free, the length of a segment Seg2 is such that the sum of the minimum length of the bridge 12 and of the length of the segment Seg2 is equal to the maximum bridge fabrication reach Dₘₐₓ.

It should be noted that the minimum length of a bridge 12 is the distance, evaluated in the direction of the bridge, separating the n points supported by this bridge.

If only one end point is free, the length of the segment Seg2 is such that the sum of the length of the bridge 12 and of the length of the segment Seg2 is equal to the maximum bridge fabrication reach Dₘₐₓ.

The segments constructed in this step are stored in a set S.

In the step 218, the method continues with the creation of events e associated with the segments of the set S. An event is either a point P of the set E (point P_{S} on the surface of the object or free end point P_{E} of a bridge, possibly of the connecting bridge type), or an intersection P_{I} between two segments of the set S.

The list of the events is denoted Q. It is ordered according to the ascending value of the coordinate of the events e according to the scanning direction, in this case according to the X axis of the events.

Then, the method enters into a loop 220 relating to events e of the list Q.

On each iteration of the loop 220, the current event e is removed from the list Q (step 222), such that the method leaves the loop 220 when the list Q is empty.

In the step 224, the scanning plane is placed on the event e.

Then, all the points P associated with segments of the set S which intersect (at points of intersection PI) the scanning plane are placed in a list PP(e). These are segments from the list S which, according to the scanning direction, begin before the event e and end after the event e. In particular, the segments deriving from the current event e are retained. A list PP(e) is obtained for each event e of the list Q. Each list PP(e) is ordered according to the coordinate Y of the scanning plane.

Then, in the step 226, for each list PP(e), all the sublists PPS(e) of points are considered. If the list PP(e) corresponds to the set (P0, . . . Pi, . . . Pn), all the sublists (Pj, . . . ,Pk) such that the distance, according to the direction Y, between the points Pj and Pk is less than the maximum reach Dₘₐₓ, will then be considered.

Each sublist PPS(e) is then evaluated to determine if it is possible to construct a bridge which would make it possible to hold up all or part of the points P of this sublist PPS(e)=(Pj, . . . ,Pk), by as many pillars 14 and connectors 16, deriving from this possible bridge.

In the step 228, the height of each point of the current sublist PPS(e)=(Pj, . . . ,Pk) is reduced by a predetermined minimum height hₘᵢₙ corresponding to the minimum height of a connector 16. A list of possible heights (hj, . . . ,hk) for the sublist PPS(e)=(Pj, . . . ,Pk) is thus obtained.

Then, for each height of this list of heights, a possible bridge PPS(e,h) is determined that makes it possible to support the points of the list PPS(e); that is to say the points whose height is greater than the current height and which can be reached by a connector.

In the step 230, it is verified that a possible bridge and any bridges 14 and connectors 16 that it is likely to bear does not collide with the object 2 to be printed.

The evaluation continues with a step 232 of calculation of a gain function G making it possible to quantify the benefit of replacing n vertical pillars supporting the points of the list PPS(e,h) and bearing on the base plane XY, with a bridge 14 supporting n shorter vertical pillars supporting the points of the list PPS(e,h), the bridge itself bearing on the base plane XY by at least two vertical pillars.

In the embodiment currently envisaged, and as is represented in FIG. 9, a possible bridge of length l and of height h, supporting n elements and supported by two vertical pillars exhibits a gain G of:

G=(n−2)xh−l

With such a gain function, only the case of a possible bridge supporting more than two pillars is favorable.

In a variant embodiment, to take account of the case where an end of a possible bridge is located above the object, the exact length of the vertical pillar linking this end to the object is used in place of the height of the bridge measured relative to the base plane. Thus, the gain function becomes:

G=n×h−h1−h2−l

in which h1 and h2 are the exact heights of the pillars at the ends of the possible bridge.

It should be noted that the lowering of the height h of a possible bridge PPS(e,h) reduces its gain G, such that a possible bridge has a maximum gain at the distance hₘᵢₙ below the lowest point that it supports.

Only the possible bridges PPS(e,h) for which the gain is positive (G>0) are ultimately retained.

Then, in the step 234, a score function F is calculated for each possible bridge PPS(e,h) of positive gain.

In the embodiment currently envisaged, this score function is defined by:

F=G−n×lₘₐₓ

where lₘₐₓ is the greatest of the heights out of the heights of the different vertical pillars bearing on the possible bridge PPS(e,h) considered, as is illustrated by FIG. 9.

Such a score function F penalizes a non-uniform distribution of the heights of the vertical elements bearing on the possible bridge PPS(e,h) considered.

Once all the events of the list Q have been considered, in the step 236, the possible bridge PPS(e,h) of positive gain having the highest score F (possibly a negative score) out of the possible bridges determined in the scanning according to the current direction d, is selected as best possible bridge BPP for this iteration of the scan.

In the step 238, the points P of the list PPS(e,h) which correspond to the best possible bridge BPP are “frozen” and a description file F10 of the support structure 10 is updated.

For a point P of the list PPS(e,h) corresponding to the intersection of a segment of the first type Seg1 with the scanning plane, an additional vertical pillar 14 is added in the file F10.

This vertical pillar 14 connects the point of the best possible bridge (of height h) corresponding to the intersection, in the plane XY, between the segment Seg1 and the scanning plane placed at e.

This pillar 14 possibly supports, at its end, an inclined connector 16 to cover the distance between the intersection, in the plane XY, between the segment Seg1 and the scanning plane placed at e and the point of the list PPS(e,h) corresponding to this segment Seg1.

For a point P of the list PPS(e,h) corresponding to a segment of the second type Seg2, the bridge 12 corresponding to this segment Seg2 is extended to the vertical of the point of intersection, in the plane XY, of the segment Seg2 and of the scanning plane placed at e. A vertical pillar is then provided to connect the point of the best possible bridge BPP corresponding to this intersection and the end point of the bridge 12 displaced to the vertical from this point of intersection. If this segment Seg2 corresponds to a bridge 12 of which the other end is a free end point, the length of the segment associated with this other end is recalculated to observe the constraint on the maximum reach Dₘₐₓ of a bridge.

Thus, a connector 16 appears as a means making it possible to relax the constraint on the distance, evaluated in the plane XY, between a point to be supported and a bridge making it possible to support this point, this bridge belonging to the scanning plane. Consequently, it is not necessary for a point to be supported to be strictly vertical to a bridge making it possible to support it. It is sufficient for it not to be too far away from it for a connector 16 to be able to connect this point to a vertical pillar deriving from this bridge.

The file F10 of the structure is thus updated with the information available for the different points “frozen”.

In the step 240, the different points P supported by the best bridge BPP=PS(e,h) are eliminated from the set E of the points to be supported. On the other hand, the end points of the best bridge BPP are added to the set E. These free end points correspond to the minimum length lₘᵢₙ of the best bridge BPP selected given the n elements that it supports.

The method is iterated with a new scanning direction.

When an iteration of the scan does not make it possible to determine a best possible bridge, the method 200 goes on to the step 250. The remaining points of the set E are then supported by pillars 14 extended to the base plane XY, or, if necessary, to the portion of the surface of the object situated below, on which they bear. The description file F10 of the structure is updated.

A constraint can possibly be implemented on the maximum height of a pillar 14. If this height is exceeded, the pillar is reduced and is supported by an additional bridge.

Then, the description file of the support structure and that of the object are merged to make it possible to generate a command file making it possible to print the object and the support structure by a filament 3D printer.

It should be noted that the gain function can be modified to discourage the formation of bridges whose ends are above the surface of the object to be fabricated. The gain and score functions allow for a great flexibility and control of the structure. Furthermore, artificial events can be added to the list Q to guide the form of the structure.

1. A method for determining a set of points to be supported for an object to be fabricated by implementation of an additive fabrication method, the method comprising: subdividing the object into successive layers, each layer corresponds to a thickness of material deposited during the fabrication of the object; and, for each layer, adding, to a set of points to be supported, the points to be supported on the surface of the object are effective to guarantee the stability of sub-objects of the object, wherein each sub-object is a solid resulting from the fabrication of a number of layers of the object.

2. The method of claim 1, further comprising, to guarantee the stability of any sub-object, checking that each sub-object placed on a horizontal base plane is in stable static equilibrium, and checking whether a center-of-mass disk that corresponds to the projection of the center of mass is entirely situated within a base surface of the sub-object, wherein the center-of-mass disk includes a predefined radius.

3. The method of claim 2, wherein, if the sub-object is unstable, the method further comprises increasing the base surface of the sub-object by providing at least one substantially vertical support element between a point of contact of the base plane located outside the base surface and a point to be supported on the surface of the sub-object projected vertically outside of the base plane of the sub-object and located at a distance from said point of contact less than a distance corresponding to the predefined radius of said center-of-mass disk, wherein the point to be supported on the surface of the sub-object thus defined being added to the set of the points to be supported.

4. The method of claim 3, wherein the substantially vertical support element is a vertical pillar linking the point of contact and the point to be supported on the surface of the sub-object, or a vertical pillar and a horizontal connecting bridge connecting the top end of the vertical pillar and the point to be supported on the surface of the sub-object.

5. The method of claim 1, wherein, prior to adding, to a set of the points to be supported, points to be supported on the surface of the object, the method further comprises, for each layer:
defining at least one path for fabrication of the current layer; and, for each point of a plurality of points along said path;
testing a condition of support, by the preceding layer, of the material deposited at the point considered; and,
in case of noncompliance with the support condition, adding the unsupported point to the set of the points to be supported.

6. The method of claim 5, further comprising, in case of noncompliance with the support condition, verifying a distance criterion, wherein the unsupported point is being added to the set of the points to be supported if a distance between the unsupported point and a neighboring point, belonging to the set of the points to be supported, is greater than a threshold distance.

7. The method of claim 5, wherein when the path is a perimeter path type, the path belongs to a portion of the perimeter of the current layer, and when the path is an internal path type, the path belongs to an internal portion of the current layer, wherein for an unsupported point of a path of the perimeter path type, verifying the distance criterion includes evaluating a curvilinear distance along a path between the unsupported point and a first neighboring point, wherein the first neighboring point is the closest point out of the set of the points to be supported which belong to the current layer; and wherein for an unsupported point of a path of the internal path type, verifying the distance criterion includes evaluating a rectilinear distance between the unsupported point and a second neighboring point, wherein the second neighboring point is the point closest to the unsupported point out of the set of the points to be supported which belong to the current layer and to the layers below the current layer.

8. The method of claim 5, further comprising determining the plurality of points to be considered by testing a support condition, wherein each path is broken down into elementary paths extending between two successive angular points of the path, and, when the length of an elementary path is greater than a threshold length, subdividing the elementary path into as many elementary paths, the plurality of points include the ends of each of the elementary paths.

9. The method of claim 5, wherein testing the support condition includes calculating the fraction of the surface of a disk which covers the preceding layer, the disk being centered on the point considered and having a predefined radius, the point considered being unsupported when the fraction is less than a threshold fraction.

10. The method of claim 5, wherein the set of the points to be supported are effective to guarantee that the filament is held up during the fabrication of the object by the implementation of an additive fabrication method using a filament 3D printer.

11. (canceled)

12. A support structure for supporting an object during its fabrication by implementing an additive fabrication method, the support structure and the object being printed simultaneously, characterized in that it supports the object at a plurality of points belonging to a set of the points to be supported resulting from the implementation of a method for determining a set of points to be supported as claimed in claim 1.

13. The structure as claimed in claim 12, comprising at least one substantially vertical element between a point of contact of a base plane and a point to be supported on the surface of the object belonging to the set of the points to be supported, said substantially vertical element being either a vertical pillar, linking the point of contact and the point to be supported, or a vertical pillar and a horizontal connecting bridge connecting the top end of said vertical pillar to said point to be supported.

14. The structure as claimed in claim 12, consisting of a plurality of horizontal and rectilinear bridges, vertical pillars and inclined connectors, a bottom end of a pillar resting on a bridge, on a base plane or on the surface of the object, and a top end of a pillar bearing a connector, and a bottom end of a connector resting on the top end of a pillar and the top end of a connector bearing a point to be supported of the object or a point to be supported of a bridge, each bridge being supported at least at each of its two end points, either by a pillar or by a point to be supported of the object.

15. A non-transitory computer accessible medium having stored thereon computer executable instructions to perform a procedure to determine a set of points to be supported for an object to be fabricated by implementation of an additive fabrication method, the procedure comprising:
subdividing the object into successive layers, each layer corresponds to a thickness of material deposited during the fabrication of the object; and
for each layer, adding, to a set of points to be supported, the points to be supported on the surface of the object are effective to guarantee the stability of sub-objects of the object, wherein each sub-object is a solid resulting from the fabrication of a number of layers of the object.
